(19) United States
(12) Patent Application Publication
(10) Pub. No.: US 2017/0078449 A1
(43) Pub. Date: Mar. 16, 2017

(54) SHARED SIMULTANEOUS ACCESS TO A SINGLE INSTANCE OF A REMOTELY EXECUTING APPLICATION

(71) Applicant: rollApp, Inc., Palo Alto, CA (US)

(72) Inventors: Volodymyr Pavlov, Mountain View, CA (US); Dmytro Malenko, Dnepropetrovsk (UA); Kostiantyn Zhereb, Kyiv (UA); Sergii Trotsiuk, Dnepropetrovsk (UA); Oleksiy Strelets, Kharkiv (UA)

(73) Assignee: rollApp, Inc., Palo Alto, CA (US)

(21) Appl. No.: 15/255,051

(22) Filed: Sep. 1, 2016

Related U.S. Application Data
(60) Provisional application No. 62/218,769, filed on Sep. 15, 2015.

(51) Int. Cl. H04L 29/06; H04L 29/08

(52) U.S. Cl. CPC H04L 67/42; H04L 67/14; H04L 67/10

(57) ABSTRACT

An application is executed remotely from a first client device associated with a first user and a second client device associated with a second user. A first access level of the first user and a second access level of the second user are determined. Shared simultaneous access to a single instance of the application is provided to the first user based on the first access level and to the second user based on the second access level. Input is received based on interactions of at least one of the first user and the second user with a virtualized instance of the application. The application is remotely executed from the first client device and the second client device based on the input.

### CROSS-REFERENCE TO RELATED APPLICATIONS

The present application claims priority to U.S. Provisional Patent Application No. 62/218,769, filed on Sep. 15, 2015, which is incorporated by reference herein.

### BACKGROUND

An area of ongoing research and development is executing applications remotely. In particular, problems exist in shared access to an application executed remotely.

Other limitations of the relevant art will become apparent to those of skill in the art upon a reading of the specification and a study of the drawings.

### SUMMARY

The following implementations and aspects thereof are described and illustrated in conjunction with systems, tools, and methods that are meant to be exemplary and illustrative, not necessarily limiting in scope. In various implementations, one or more of the above-described problems have been addressed, while other implementations are directed to other improvements.

In various implementations, an application is executed remotely from a first client device associated with a first user and a second client device associated with a second user. Further, in various implementations, a first access level of the first user and a second access level of the second user are determined. In various implementations, shared simultaneous access to a single instance of the application is provided to the first user based on the first access level and to the second user based on the second access level. In various implementations, input is received based on interactions of at least one of the first user and the second user with a virtualized instance of the application. Additionally, in various implementations, the application is remotely executed from the first client device and the second client device based on the input. While the systems and methods are discussed with respect to a first client device and a second client device of a first user and a second user, in various implementations, more than two client devices corresponding to more than two users can have shared simultaneous access to a single instance of an application of a remotely executed application.

These and other advantages will become apparent to those skilled in the relevant art upon a reading of the following descriptions and a study of the several examples of the drawings.

### BRIEF DESCRIPTION OF THE DRAWINGS

FIG. 1 depicts a diagram of an example of a system for providing shared simultaneous access to a remotely executed application.

FIG. 2 depicts a diagram of an example of a system for registering users for providing shared access to a single instance of an application executed remotely.

FIG. 3 depicts a diagram of an example of a system for transparently accessing local storage of a client device to provide data associated with a remotely executing application accessed by the client device.

FIG. 4 depicts a diagram of an example of a system for using locally stored data in executing an application remotely from a client device.

FIG. 5 depicts a flowchart of an example of a method for providing shared simultaneous access to an instance of an application executed remotely from client device.

FIG. 6 depicts a flowchart of an example of a method for managing access levels of users to access a single instance of an application executed remotely.

FIG. 7 depicts a flowchart of an example of a method for providing access to a single instance of a remotely executed application according to access levels.

FIG. 8 depicts a flowchart of an example of a method for transferring data associated with an application executed remotely from a client device to a local storage of the client device.

FIG. 9 depicts a flowchart of an example of a method for using data in a local storage of a client device in the execution of an application remote from the client device.

### DETAILED DESCRIPTION

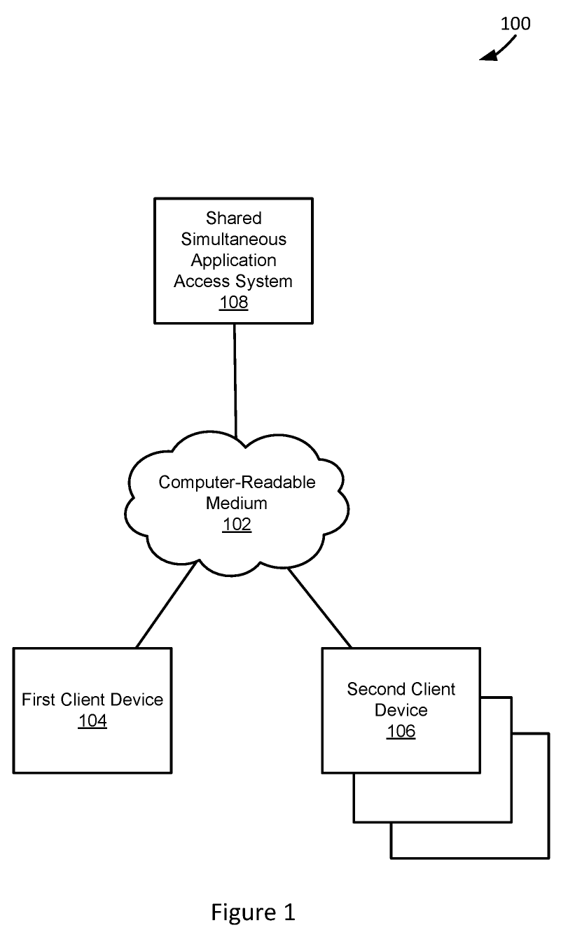

FIG. 1 depicts a diagram 100 of an example of a system for providing shared simultaneous access to a remotely executed application. The system of the example of FIG. 1 includes a computer-readable medium 102, a first client device 104, a second client device 106, and a shared simultaneous application access system 108.

The first client device 104, the second client device 106, and the shared simultaneous application access system 108 are coupled to each other through the computer-readable medium 102. As used in this paper, a “computer-readable medium” is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The computer-readable medium 102 is intended to represent a variety of potentially applicable technologies. For example, the computer-readable medium 102 can be used to form a network or part of a network. Where two components are co-located on a device, the computer-readable medium 102 can include a bus or other data conduit or plane. Where a first component is co-located on one device, and a second component is located on a different device, the computer-readable medium 102 can include a wireless or wired back-end network or LAN. The computer-readable medium 102 can also encompass a relevant portion of a WAN or other network, if applicable.

The computer-readable medium 102, the first client device 104, the second client device 106, the shared simultaneous application access system 108, and other applicable systems, or devices described in this paper can be implemented as a computer system, a plurality of computer systems, or parts of a computer system or a plurality of computer systems. A computer system, as used in this paper, is intended to be construed broadly. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, solid state storage, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software and local cache that ideally serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and, for the purposes of this paper, can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine, or through multiple engines. As used in this paper, an engine includes one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors, or a first engine and a second engine can share one or more processors with one another or other engines. Depending upon implementation-specific or other considerations, an engine can be centralized or its functionality can be distributed. An engine can include hardware, firmware, or software embodied in a computer-readable medium for execution by the processor. The processor transforms data into new data using implemented data structures and methods, such as is described with reference to the FIGS. in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

The first client device 104 and the second client device 106 function to send and receive data used in providing simultaneous shared access to a single instances of an application executing remotely from the first client device 104 and the second client device 106. As used in this paper, an application executing remotely from a client device is an application that is executed remotely relative to the client device. While the example system shown in FIG. 1 only illustrates a first client device 104 and a second client device 106, more two client devices can be coupled at any given time for gaining shared simultaneous access to a single instance of an application executing remotely. Depending upon implementation-specific or other considerations, the first client device 104 and the second client device 106 can include a wireless interface through which the first client device 104 and the second client device 106 can be coupled to the computer-readable medium 102 through a wireless connection. Further depending upon implementation-specific or other considerations, the first client device 104 and/or the second client device 106 can be a thin client device or an ultra-thin client device. The first client device 104 and the second client device 106 can include one or a plurality of interfaces used in viewing or interacting with a single instance of application executing remotely. For example, the first client device 104 and/or the second client device 106 can include a display for viewing a single instance of an application executing remotely.

The shared simultaneous application access system 108 functions to provide shared simultaneous access to an instance of an application. The shared simultaneous application access system 108 is implemented, at least in part, remote from client devices accessing a single instance of an application. For example, the shared simultaneous application access system 108 can be implemented, at least in part, within the cloud. The shared simultaneous application access system 108 can execute an application remote from client devices in providing shared simultaneous access for the client devices to a single instance of the application. As used in this paper, access includes providing a visual copy of an instance of an application as it is executing remotely and/or providing a virtualized instance of an application as it is executing remotely to give the appearance that the application is being executed locally when it is actually being executed remotely. As used in this paper, a visual copy of an instance of an application is a view of visual output of an application as it is executing that can only be viewed. As used in this paper, a virtualized instance of an application is a copy of an instance a user can interact with in order to generate input for controlling execution of the application remotely. In executing an application remote from client devices while providing access for the client devices to a single instance of the application, the application appears to be executed locally on the client devices even though it is being executed remotely.

In a specific implementation, the shared simultaneous application access system 108 provides access to a single instance of an application executing remotely from client devices through an application executing on the client devices. Depending upon implementation-specific or other considerations, the shared simultaneous application access system 108 can provide access to a single instance of a remotely executed application through a native application executing on client devices. Further depending upon implementation-specific or other considerations, the shared simultaneous application access system 108 can provide access to a single instance of a remotely executed application through a web-based application accessed through a web browser executing on client devices.

In a specific implementation, the shared simultaneous application access system 108 manipulates execution of an application based on input received from a user accessing a single instance of the application. In manipulating execution of an application, the shared simultaneous application access system 108 can control the execution of the application according to received input in response to a broadcasted visual copy of the application as it is being executed. For example, if an application is a word processing program and a user clicks on a font tab in a broadcasted visual copy of the application, then the shared simultaneous application access system 108 can execute the word processing program according to if a user had clicked on the font tab. As a result, a user can seamlessly control an application executing remote from a client device of the user as if the application was being executed locally on the client device even though it is being executed remotely.

In a specific implementation, the shared simultaneous application access system 108 provides access to a single instance of an application according to access levels. Access levels include whether a user has passive access to an instance of an application or control access to an instance of the application. As used in this paper, passive access is the ability to view but not control execution of an application or the ability to view but not edit media created as a result of execution of an application through a broadcast visual copy of a single instance of the application. Depending upon implementation-specific or other considerations, passive access can be the ability to view all or only a specific portion of media created as a result of execution of an application. For example, if an application is a word processing program then passive access can be the ability to view all of a created document as a result of execution of an application or specific portions of the created document. Additionally, as used in this paper control access is the ability to control execution of the application through a broadcasted virtualized instance of an application. For example, if an application is a word processing program, then control access can include being able to control editing the document using the word processing program. Depending upon implementation-specific or other considerations, all users can simultaneously or at different times have control access to a single instance of an application. For example, a first user can have control access to a single instance of an application and give up control access to a second user.

In a specific implementation, the shared simultaneous application access system 108 controls access to a single instance of an application according to access levels through tokens. As used in this paper, a token signifies that a user has control access to an application. Depending upon implementation-specific or other considerations, the shared simultaneous application access system 108 can provide tokens to users at the beginning of a session of accessing a single instance of an application executed remotely. For example, when the shared simultaneous application access system 108 begins executing an application remotely, then the shared simultaneous application access system 108 can automatically provide a token to a user specified to control the application. Further depending upon implementation-specific or other considerations, the shared simultaneous application access system 108 can facilitate transfer of tokens between users as control access switches between the users. For example, if a first user hands off control access of a single instance of an application executing remotely to a second user, then the shared simultaneous application access system 108 can transfer a token from the first user to the second user.

In a specific implementation, the shared simultaneous application access system 108 allows a user to claim a token for controlling access to a single instance of an application executing remotely. Depending upon implementation-specific or other considerations, the shared simultaneous application access system 108 can automatically provide a token to a user claiming a token. Further depending upon implementation-specific or other consideration, the shared simultaneous application access system 108 can check access rules before providing a token to a user claiming a token. As used in this paper, access rules are rules dictating access levels. For example if a user claims a token and access rules specify that the user is not allowed to have control access, then the shared simultaneous application access system 108 can deny the user the token. Depending upon implementation-specific or other considerations, the shared simultaneous application access system 108 can provide a token in response to a user's claim to a token, based upon whether the token is checked out. As used in this paper, a token is checked out if it has been given to a specific user. For example, if a first user claims a token and the token is checked out to a second user, then the shared simultaneous application access system 108 can deny the first user the token.

In a specific implementation, the shared simultaneous application access system 108 executes an application to create multiple instances of the application that can be simultaneously be accessed by different users or groups of users. In creating multiple instances of an application capable of being simultaneously being accessed by different groups of users, the shared simultaneous application access system 108 can maintain multiple sessions simultaneously. For example, the shared simultaneous application access system 108 can maintain a first instance of an application for a first group of users and maintain a second instance of the application for a second group of users simultaneously.

In a specific implementation, the shared simultaneous application access system 108 continues executing an application even if a user disconnects from a session for an instance of the application. For example, if a first and second user are participating in a session for an instance of application, and the first user experiences a connection disruption and subsequently disconnects, then the shared simultaneous application access system 108 can maintain the session of the instance of the application. Depending upon implementation-specific or other considerations, the shared simultaneous access system 108 can manage a session for an instance of an application when a user disconnects according to access levels. For example, if a first user with control access and a second user with passive access are participating during a session of an instance of an application, and the second user disconnects unexpectedly, then the shared simultaneous application access system 108 can continues the session without doing anything. In another example, if a first user with control access and a second user with passive access are participating during a session of an instance of an application, and the first user disconnects unexpectedly, then the shared simultaneous application access system 108 can give control access to the second user.

In a specific implementation, the shared simultaneous application access system 108 transparently accesses local storage of a client device to provide data associated with a remotely executing application accessed by the client device. Data associated with executing an application can include data generated through execution of the application. For example, if a client device is accessing a single instance of a word processing application executing remotely, then the shared simultaneous application access system 108 can transparently access local storage of the client device to provide a document generated during execution of an application to create a single instance of the application. Depending upon implementation-specific or other considerations, the shared simultaneous application access system 108 can access local storage of a client device through an application executing at the client device to provide data associated with a remotely executing application access by the client device. For example, the simultaneous application access system 108 can provide data through a web browser. Further depending upon implementation-specific or other considerations, the simultaneous application access system 108 can transparently access local storage of a client device through a virtualized file system of the client device. For example, the shared simultaneous application access system 108 can transparently access local storage of a client device by spoofing a file system of the client device to create a virtualized file system used to automatically save data on the client device.

In a specific implementation, the shared simultaneous application access system 108 maintains a synchronized datastore containing data that is concurrently stored locally at a client device participating in a session. Data maintained in a synchronized datastore can be used in executing an application remotely. A synchronized datastore maintained by the shared simultaneous application system can be generated and maintained by querying a local datastore for contained data. For example, the shared simultaneous application access system 108 can maintain a synchronized datastore that contains data, e.g. notes, html elements, and pictures, entered into a clipboard of a client device. Further in the example, the shared simultaneous application access system 108 can copy the notes from the synchronized datastore and paste it into a word processing application executing remotely from the client device.

In an example of operation of the example system shown in FIG. 1, the first client device 104 and the second client device 106 device function to send and receive data used in participating in a session of a shared single instance of an application being executed remotely. In the example of operation of the example system shown in FIG. 1, the shared simultaneous application access system 108 executes the application to create the single instance of the application that users of the first client device 104 and the second client device 106 can access simultaneously. Further, in the example of operation of the example system shown in FIG. 1, the shared simultaneous application access system 108 controls access of the users of the first client device 104 and the second client device 106 to the single instance of the application based on access levels.

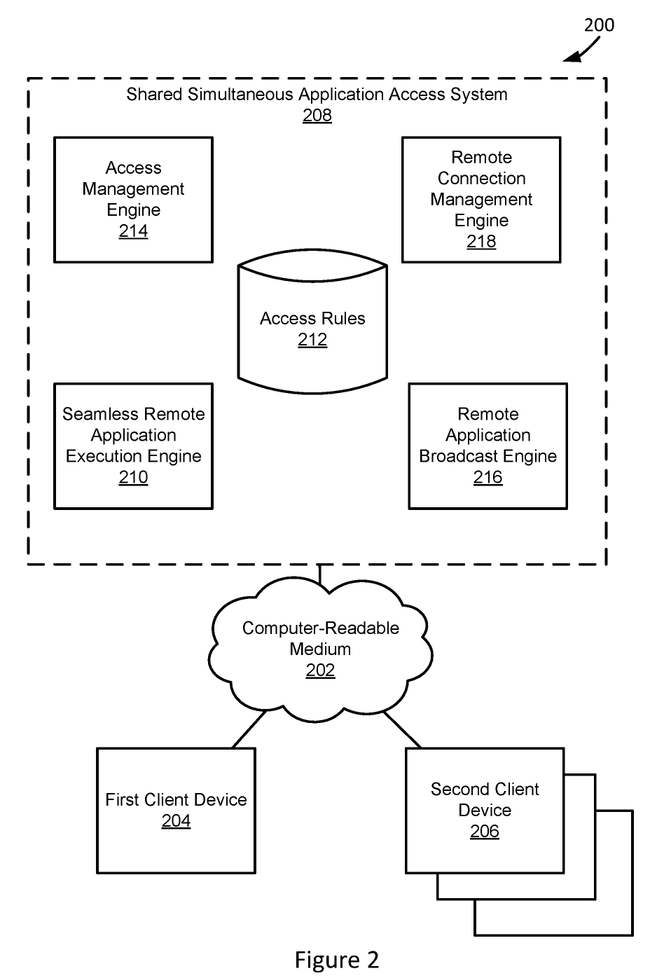

FIG. 2 depicts a diagram 200 of an example of a system for registering users for providing shared access to a single instance of an application executed remotely. The example system shown in FIG. 2 includes a computer-readable medium 202, a first client device 204, a second client device 206, and a shared simultaneous application access system 208. In the example system shown in FIG. 2, the first client device 204, the second client device 206, and the shared simultaneous application access system 208 are coupled to each other through the computer-readable medium 202.

The first client device 204 and the second client device 206 functions according to an applicable device for sending and receiving data for obtaining shared simultaneous access to a single instance of an application executing remotely, such as the client devices described in this paper. While the example system shown in FIG. 2 only illustrates a first client device 204 and a second client device 206, more two client devices can be coupled at any given time for gaining shared simultaneous access to a single instance of an application executing remotely. The first client device 204 and the second client device 206 can have the same or different access levels users associated with the corresponding devices. For example, a user of the first client device 204 can have control access to a single instance of an application while a user of the second client device 206 can have passive access to the single instance of the application. The first client device 204 and the second client device can include one or a plurality of interfaces used in viewing or interacting with a single instance of application executing remotely. For example, the first client device 204 can include a display for accessing a single instance of an application executing remotely.

The shared simultaneous application access system 208 functions according to an applicable system for managing shared simultaneous access to a single instance of an application executed remotely, such as the shared simultaneous application access systems described in this paper. The shared simultaneous application access system 208 can execute an application remote from client devices. Access can be granted by the shared simultaneous application access system 208 to an instance of an application by broadcasting a visual copy of the instance of the application as it is executing for passive access levels and/or a virtualized instance of the application as it is executing for control access levels to give the appearance that the application is being executed locally when it is actually being executed remotely. The shared simultaneous application access system 208 can execute the application according to input received from a user as they interact with a virtualized instance of the application.

The shared simultaneous application access system 208 includes a seamless remote application execution engine 210, an access rules datastore 212, an access management engine 214, a remote application broadcast engine 216, and a remote connection management engine 218.

The seamless remote application execution engine 210 functions to execute an application remote from client devices. In executing an application, the seamless remote application execution engine 210 creates an instance of the application. The seamless remote application execution engine 210 can execute an application remote from the client devices based on input received from one or more of the client devices and generated in response to interaction with a virtualized instance of the application. For example, if an application is a word processing program and in interacting with a virtualized instance of the word processing program, the user activates a file load command, then the seamless remote application execution engine 210 can execute the word process program to cause a file to be displayed.

In a specific implementation, the seamless remote application execution engine 210 concurrently executes an application multiple times to create concurrently existing instances of the application. In concurrently executing an application multiple times to create concurrently existing instances of the application, the seamless remote application execution engine 210 can execute each instance of the application according to input received from users interacting with virtualized instances of the application. For example, if first input is received for a first instance of an application based on interaction with a virtualized first instance of the application and second input is received for a second instance of an application based on interaction with a virtualized second instance of the application, then the seamless remote application execution engine 210 can execute the application for the first instance of the application according to the first input and execute the application for the second instance of the application according to the second input.

In a specific implementation, the seamless remote application execution engine 210 continues executing an application even if a user disconnects from a session for an instance of the application. For example, if a first and a second user are participating in a session for an instance of application, and the first user experiences a connection disruption and subsequently disconnects, then the seamless remote application execution engine 210 can maintain the session of the instance of the application.

The access rules datastore 212 functions to store access rules data indicating access rules. Access rules indicated by the access rules data stored in the access rules datastore 212 define rules for providing access to an application executed remotely. For example, access rules can specify that only specific users are allowed to have control access to an instance of an application executing remotely. In another example, access rules can specify that whoever has a token has control access to an instance of an application executing remotely. Depending upon implementation-specific or other considerations, access rules can be defined by an administrator. For example, an administrator can define access rules specifying that only administrators in a plurality of users can have control access to an instance of an application executed remotely. Further depending upon implementation-specific or other considerations, access rules can be created according to past interactions of users with an instance of an application. For example, if in the past specific users gained control access to an instance of an application, then access rules can be created specifying that the specific users are allowed to have access control.

The access management engine functions to manage access levels of users in accessing an instance of an application executing remotely. In managing access levels of users, the access management engine 214 can determine an access level of a user. In determining access levels of users, the access management engine 214 can determine if a user has passive access or control access. Depending upon implementation-specific or other considerations, the access management engine 214 can determine an access level of users based on access rules. For example, the access management engine 214 can determine that a user has control access to an instance of an application executed remotely if access rules specify that the user has control access. In another example, if an application is a word processing program, then the access management engine 214 can determine that a user has passive access to an instance of the word processing program. Depending upon implementation-specific or other considerations, the access management engine 214 can determine that all users have simultaneous control access to a single instance of an application or at different times have control access to the single instance of the application. For example, the access management engine 214 can determine a first user has control access to a single instance of an application and a second user has control access to the single instance of the application.

In a specific implementation, the access management engine 214 determines access levels to a single instance of an application according to tokens. Depending upon implementation-specific or other considerations, the access management engine 214 can provide tokens to users at the beginning of a session of accessing a single instance of an application executed remotely. For example, when the application is beginning execution remotely, then the access management engine 214 can automatically provide a token to a user specified to control the application. Further depending upon implementation-specific or other considerations, the access management engine 214 can facilitate transfer of tokens between users as control access switches between the users. For example, if a first user hands off control access of a single instance of an application executing remotely to a second user, then the access management engine 214 can transfer a token from the first user to the second user.

In a specific implementation, the access management engine 214 allows a user to claim a token for controlling access to a single instance of an application executing remotely. Depending upon implementation-specific or other considerations, the access management engine 214 can automatically provide a token to a user claiming a token. Further depending upon implementation-specific or other consideration, the access management engine 214 can check access rules before providing a token to a user claiming a token. For example if a user claims a token and access rules specify that the user is not allowed to have control access, then the access management engine 214 can deny the user the token. Depending upon implementation-specific or other considerations, the access management engine 214 can provide a token in response to a user's claim to a token, based upon whether the token is checked out. For example, if a first user claims a token and the token is checked out to a second user, then the access management engine 214 can deny the first user the token.

In a specific implementation, the access management engine 214 manages access levels when a user disconnects. For example, if a first user with control access and a second user with passive access are participating during a session of an instance of an application, and the second user disconnects unexpectedly, then the access management engine 214 can determine that access levels remain the same. In another example, if a first user with control access and a second user with passive access are participating during a session of an instance of an application, and the first user disconnects unexpectedly, then the access management engine 214 can give control access to the second user.

The remote application broadcast engine 216 functions to broadcast an instance of an application executing remotely. The remote application broadcast engine 216 can send either or both a visual copy of an instance of an application and a virtualized instance of the application to client devices. For example, the remote application broadcast engine can simultaneously broadcast a visual copy of an instance of an application to a first user and a virtualized instance of the application to a second user. The remote application broadcast engine 216 can broadcast an instance of an applicable executing remotely through an applicable method and/or mechanism for broadcasting instances of an application. For example the remote application broadcast engine 216 can send a visual copy of an instance of an application or a virtualized instance of the application to a client device through a native application executing on a client device or through a web based application running in a web browser executing on a client device.

In a specific implementation, the remote application broadcast engine 216 broadcasts an instance of an application executed remotely according to access levels of user. In broadcasting according to access levels, the remote application broadcast engine 216 can broadcast visual copies of an instance of an application to users who have passive access and a virtualized instance of the application to users who have control access. For example if a remotely executing application is a word processing program, and a first user has control access, then the remote application broadcast engine 216 can send a virtualized instance of the word processing program that the first user can interact with to the first user.

The remote connection management engine 218 functions to manage connections of users accessing an instance of an application executing remotely. In managing connections, the remote connection management engine 218 can determine if a user remains connected. Depending upon implementation-specific or other considerations, the remote connection management engine 218 can determine if a user is connected by pinging a user during a session. The remote connection management engine 218 can ping a user continuously or according to established time intervals. Further depending upon implementation-specific or other considerations, the remote connection management engine 218 can determine if a user is connected based on whether visual copies of an instance of an application or virtualized instances of the application are being successfully sent to a client device. For example, if visual copies of an instance of an application are not being successfully transmitted to a client device utilized by a user, then the remote connection management engine 218 can determine that the user is not connected.

In a specific implementation, the remote connection management engine 218 provides functionalities for users to communicate with each other while accessing an instance of an application executing remotely. In providing functionalities for users to communicate, the remote connection management engine 218 can transmit data between client devices to establish a communication channel for users. Depending upon implementation-specific or other considerations, the remote connection management engine 218 can transmit audio data between client devices to establish an audio channel. For example, if a first user and a second user wish to talk with each other while editing a document in a remotely executed word processing program, then the remote connection management engine 218 can transmit audio data between corresponding client devices utilized by the first user and the second user to establish an audio channel. Further depending upon implementation-specific or other considerations, the remote connection management engine 218 can transmit text data between first and second users in establishing a communication channel. Text data can be input by users through a separate interface provided to the user through a native application or a web-based application executing at a client device. For example, a user can input text though a chat window, which can be transmitted to another user using the remote connection management engine 218.

In an example of operation of the example system shown in FIG. 2, the seamless remote application execution engine 210 executes an application remotely from the first client device 204 and the second client device 206 to create a single instance of the application. In the example of operation of the example system shown in FIG. 2, the access management engine 214 determines access levels for a first user utilizing the first client device 204 and a second user utilizing the second client device 206 according to access rules indicated by access rules data stored in the access rules datastore 212. Further, in the example of operation of the example system shown in FIG. 2, the remote application broadcast engine 216 broadcasts either a visual copy of the instance of the application or a virtualized instance of the application to the first client device 204 and the second client device 206 according to determined access levels of the first user and the second user. In the example of operation of the example system shown in FIG. 2, the remote connection management engine 218 determines if the first user and the second user remain connected in accessing the single instance of the application.

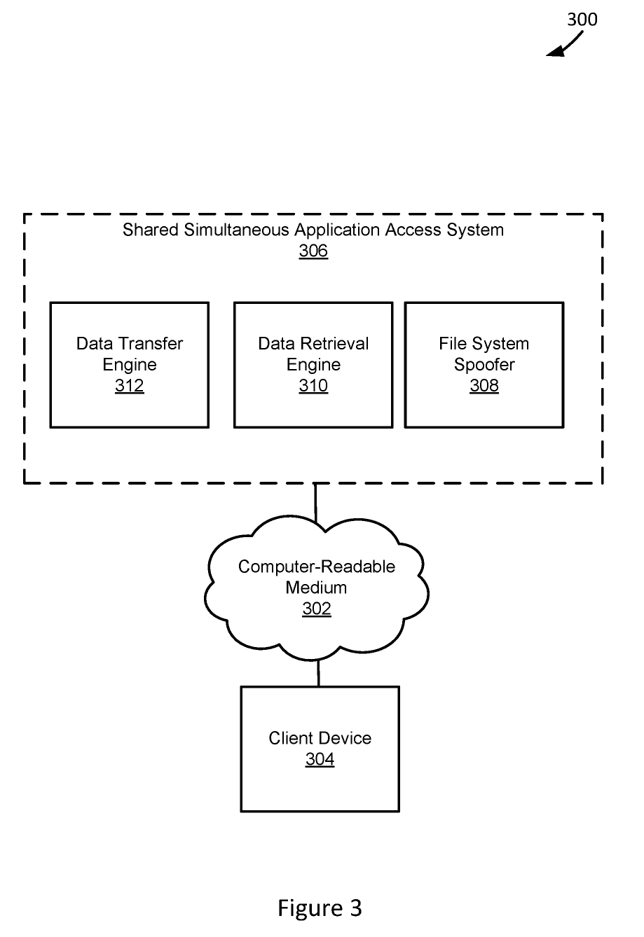

FIG. 3 depicts a diagram 300 of an example of a system for transparently accessing local storage of a client device to provide data associated with a remotely executing application accessed by the client device. The example system shown in FIG. 3 includes a computer-readable medium 302, a client device 304, and a shared simultaneous application access system 306. In the example system shown in FIG. 3, the client device 304 and the shared simultaneous application access system 306 are coupled to each other through the computer-readable medium 302.

The client device 304 functions according to an applicable device for sending and receiving data in sharing simultaneous access to a single instance of an application executing remotely, such as the client devices described in this paper. The client device 304 can include one or a plurality of interfaces used in viewing or interacting with a single instance of application executing remotely. For example, the client device 304 can include a display for accessing a single instance of an application executing remotely. The client device 304 can include local storage that can be accessed for storing data associated with a remotely executed application accessed by a user of the client device 304.

The shared simultaneous application access system 306 functions according to an applicable system for managing shared simultaneous access to a single instance of an application executed remotely, such as the shared simultaneous application access systems described in this paper. The shared simultaneous application access system 306 can execute an application remote from client devices. Access can be granted by the shared simultaneous application access system 306 to an instance of an application by broadcasting a visual copy of the instance of the application as it is executing for passive access levels and/or a virtualized instance of the application as it is executing for control access levels to give the appearance that the application is being executed locally when it is actually being executed remotely. The shared simultaneous application access system 306 can execute the application according to input received from a user as they interact with a virtualized instance of the application.

The shared simultaneous application access system 306 functions to transparently access local storage of a client device to provide data associated with a remotely executed application accessed by the client device. Depending upon implementation-specific or other considerations, the shared simultaneous application access system 306 can access local storage of a client device through an application executing at the client device. For example, the shared simultaneous application access system 306 can provide data through a web browser. Further depending upon implementation-specific or other considerations, the shared simultaneous application access system 306 can transparently access local storage of a client device through a virtualized file system of the client device. For example, the shared simultaneous application access system 306 can transparently access local storage of a client device by spoofing a file system of the client device to create a virtualized file system used to automatically save data on the client device. In various implementations, the shared simultaneous application access system 306 can access local storage of one client device associated with one user, access local storage of a plurality of client devices associated with one user, access local storage of a plurality of client devices associated with a plurality of users, and/or access a plurality of local storages of a client device. For example, the shared simultaneous application access system 306 can access local storage of all client devices utilized by users participating during a session.

In the example system shown in FIG. 3, the shared simultaneous application access system 306 includes a file system spoofer 308, a data retrieval engine 310, and a data transfer engine 312.

The file system spoofer 308 functions to spoof a file system of a client device accessing an instance of a remotely executed application to create a virtualized file system. The file system spoofer 308 can spoof registries, directories, environment variables, and/or other components in creating a virtualized file system. The file system spoofer 308 can spoof file systems of a plurality of client devices to create virtualized file systems specific to each client device.

The data retrieval engine 310 functions to retrieve data associated with an application executing remotely. In various implementations, the data retrieval engine 310 can retrieve data created as a result of executing an application. For example, if an application is a word processing program, then the data retrieval engine 310 can retrieve a document created as a result of executing the word processing program. The data retrieval engine 310 can retrieve data associated with an application from a remote location to client devices accessing an instance of the application.

The data transfer engine 312 functions to transfer data associated with an application executing remotely to local storage of client devices accessing an instance of the application. In transferring data associated with an application, the data transfer engine 312 can transparently access local storage of a client device and transfer the data to the local storage. In various implementations, the data transfer engine 312 can query a user before transferring data associated with an application to a client device associated with the user. For example the data transfer engine 312 can ask a user if they want to obtain data associated with an application and either transfer or not transfer the data to the user according to feedback. In various implementations, the data transfer engine 312 can transfer data to a desired location of a user. For example, if a user wants data associated with an application saved on their desktop, then the data transfer engine 312 can save the data on the user's desktop.

In a specific implementation, the data transfer engine 312 can access local storage of a client device through an application executing at the client device. For example, the data transfer engine 312 can provide data through a web browser. In another example, the data transfer engine 312 can provide data through cloud storage of a user, e.g. iCloud®.

In a specific implementation, the data transfer engine 312 can access local storage of a client device using a virtualized file system of the client device. In accessing location storage of a client device to save data using the virtualized file system, the data transfer engine 312 can access a representation of a directory of the desired local storage in the virtualized file structure. A transparent translator, included as part of the data transfer engine 312 can translate data with an offset to a desired local storage at a client device based on a representation of a directory of the desired local storage in the virtualized file structure. In accessing local storage of a client device using a virtualized file system, the data transfer engine 312 can transfer data seamlessly without the user realizing that the application is not being executed locally.

In an example of operation of the example system shown in FIG. 3, the file system spoofer 308 creates a virtualized file system of a file system of the client device 304. In the example of operation of the example system shown in FIG. 3, the data retrieval engine 310 retrieves data associated with an application remotely executed and accessed by the client device 304. Further, in the example of operation of the example system shown in FIG. 3, the data transfer engine 312 transfers the data retrieved by the data retrieval engine 310 to local storage of the client device 304 using either or both an application executing at the client device 304 or the virtualized file structure create by the file system spoofer 308.

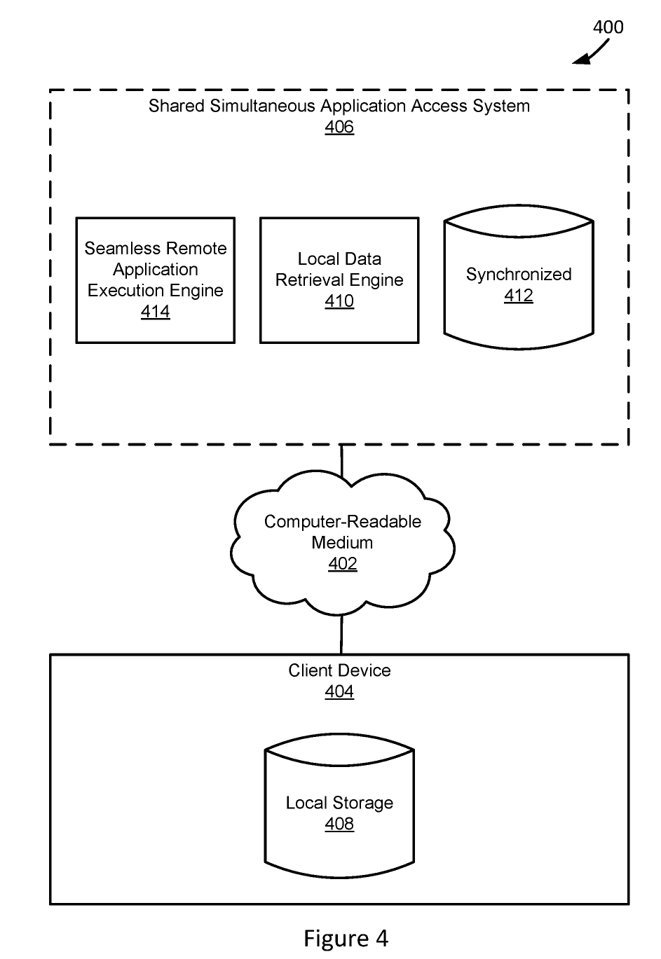

FIG. 4 depicts a diagram 400 of an example of a system for using locally stored data in executing an application remotely from a client device. The example system shown in FIG. 4 includes a computer-readable medium 402, a client device 404 and a shared simultaneous application access system 406. In the example system shown in FIG. 4, the client device 404 and the shared simultaneous application access system 406 are coupled to each other through the computer-readable medium 402.

The client device 404 functions according to an applicable device for sending and receiving data in sharing simultaneous access to a single instance of an application executing remotely, such as the client devices described in this paper. The client device 404 can include one or a plurality of interfaces used in viewing or interacting with a single instance of application executing remotely. For example, the client device 404 can include a display for accessing a single instance of an application executing remotely. The client device 404 includes local storage 408 that can be accessed for retrieving locally stored data.

The shared simultaneous application access system 406 functions according to an applicable system for managing shared simultaneous access to a single instance of an application executed remotely, such as the shared simultaneous application access systems described in this paper. The shared simultaneous application access system 406 can execute an application remote from client devices. Access can be granted by the shared simultaneous application access system 406 to an instance of an application by broadcasting a visual copy of the instance of the application as it is executing for passive access levels and/or a virtualized instance of the application as it is executing for control access levels to give the appearance that the application is being executed locally when it is actually being executed remotely. The shared simultaneous application access system 406 can execute the application according to input received from a user as they interact with a virtualized instance of the application. The shared simultaneous application access system 406 can maintain a synchronized datastore of a local datastore at a client device for use in executing an application remotely from the client device.

The shared simultaneous application access system 406 in the example system shown in FIG. 4 includes a local data retrieval engine 410, a synchronized datastore 412, and a seamless remote application execution engine 414.

The local data retrieval engine 410 functions to retrieve data from a local datastore at a client device for maintaining a synchronized datastore of the local datastore. The local data retrieval engine 410 can access local storage of a client device according to a local token. A local token signifies the right to retrieve local data. Depending upon implementation-specific or other considerations, a local token can be passed between users during a session for accessing local data.

In a specific implementation, the local data retrieval engine 410 can access local storage of a client device through an application executing at the client device. For example, the local data retrieval engine 410 can access local storage through a web browser. In another example, the local data retrieval engine 410 can access local storage through a native application executing at a client device.

In a specific implementation, the local data retrieval engine 410 can access local storage of a client device using a virtualized file system of the client device. In accessing location storage of a client device, the local data retrieval engine 410 can access a representation of a directory of the desired local storage in the virtualized file structure. A transparent translator, included as part of the local data retrieval engine 410 can access the desired local storage at a client device based on a representation of a directory of the desired local storage in the virtualized file structure.

The synchronized datastore 412 functions to store synchronized data. Synchronized data includes a copy of data stored in local storage of a client device. For example, synchronized data can include data, e.g. text, html elements, and pictures, stored within a clipboard on a client device.

The seamless remote application execution engine 414 functions according to an applicable engine for executing an application remotely from a client device, such as the seamless remote application execution engines described in this paper. The seamless remote application execution engine 414 can execute an application according how a user interacts with an instance of the application. In various implementations, the seamless remote application execution engine 414 can use synchronized data in the execution of an application. For example, if the application is a word processing program and synchronized data includes text within a clipboard on a client device, then the seamless remote application execution engine 414 can copy and paste the text from the synchronized data into a document created while executing the word processing program.

In an example of operation of the example system shown in FIG. 4, the local data retrieval engine 410 retrieves data stored in the local storage 408 of the client device 404. In the example of operation of the example system shown in FIG. 4, the synchronized datastore 412 stores synchronized data including the data retrieved by the local data retrieval engine 410. Further, in the example of operation of the example system shown in FIG. 4, the seamless remote application execution engine 414 uses the synchronized data stored in the synchronized datastore 412 in executing an application remote from the client device 404 that the client device 404 is accessing.

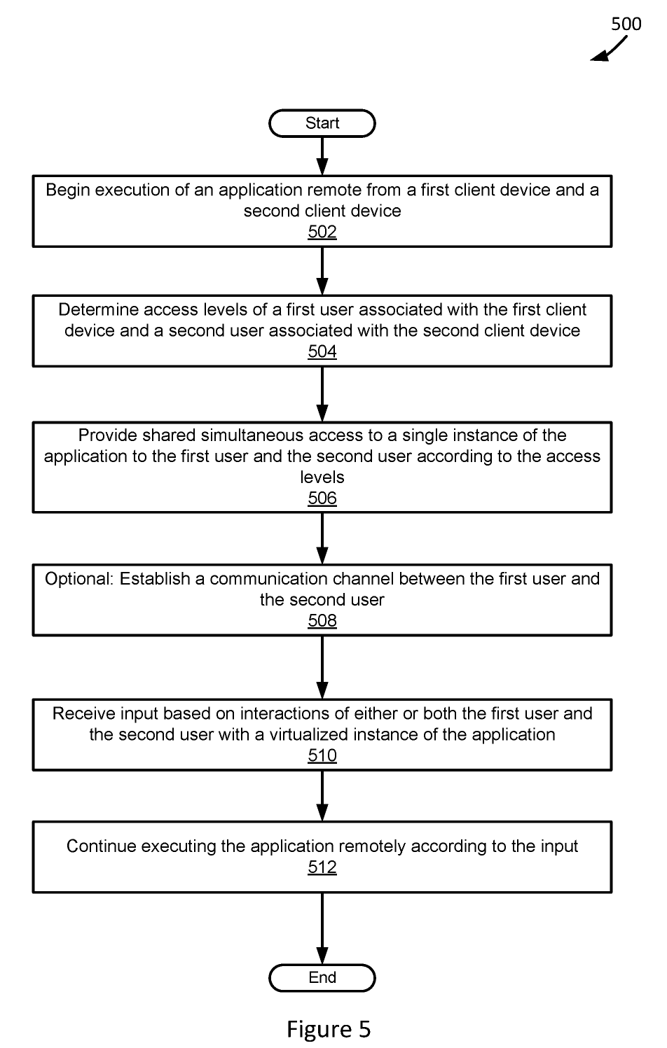

FIG. 5 depicts a flowchart 500 of an example of a method for providing shared simultaneous access to an instance of an application executed remotely from client device. The flowchart 500 begins at module 502, where an application is executed remote from a first client device and a second client device. An applicable engine for executing an application remotely from client devices, such as the seamless remote application execution engines described in this paper, can begin execution of an application remote from a first client device and a second client device. Depending upon implementation-specific or other considerations, either or both the first client device and the second client device do not have to have access to the application at the beginning of execution at module 502. For example, execution of an application can begin and a client device can subsequently connect later during a session to gain simultaneous shared access for a user.

The flowchart 500 continues to module 504 where access levels of a first user associated with the first client device and a second user associated with the second client device are determined. An applicable engine for determining access levels, such as the access management engines described in this paper, can determine access levels of a first user associated with the first client device and a second user associated with the second client device. Depending upon implementation-specific or other considerations, access levels can be determined at least in part using access rules.

The flowchart 500 continues to module 506, where shared simultaneous access to a single instance of the application is provided to the first user and the second user according to the access levels. An applicable engine for providing access to an instance of an application executing remotely, such as the remote application broadcast engines described in this paper, can provide shared simultaneous access to a single instance of the application. In providing shared simultaneous access to a single instance of the application, a visual copy of the single instance of the application or a virtualized instance can be sent to the first client device and the second device.

The flowchart 500 continues to module 508, where optionally, a communication channel between the first user and the second user is established. An applicable engine for establishing a communication channel, such as the remote connection management engines described in this paper, can establish a communication channel between the first user and the second user. A communication channel established between the first user and the second user can be one of or a combination of an audio communication channel, a video communication channel, and a text based communication channel. For example, a communication channel can be a chat window through which the first user and the second user can exchange text based messages. A communication channel can be used to collaborate in the execution of the application remotely.

The flowchart 500 continues to module 510, where input based on interactions of either or both the first user and the second user with a virtualized instance of the application is received. An applicable engine for receiving input, such as the seamless remote application execution engines described in this paper, can receive input based on interactions of either or both the first user and the second user with a virtualized instance of the application. For example, if the application is a word processing program and a user activates a font tab when interacting with a virtualized instance of the application, then input can be received indicating that the user has activated the font tab.

The flowchart 500 continues to module 512, where the application is further executed remote from the first client device and the second device according to the input. An applicable engine for executing an application remotely, such as the seamless remote application execution engines described in this paper, can continue execution of the application remote from the first client device and the second client device according to the input. In continuing to execute the application according to the input the application appears to be executed locally even though it is actually being executed remotely.

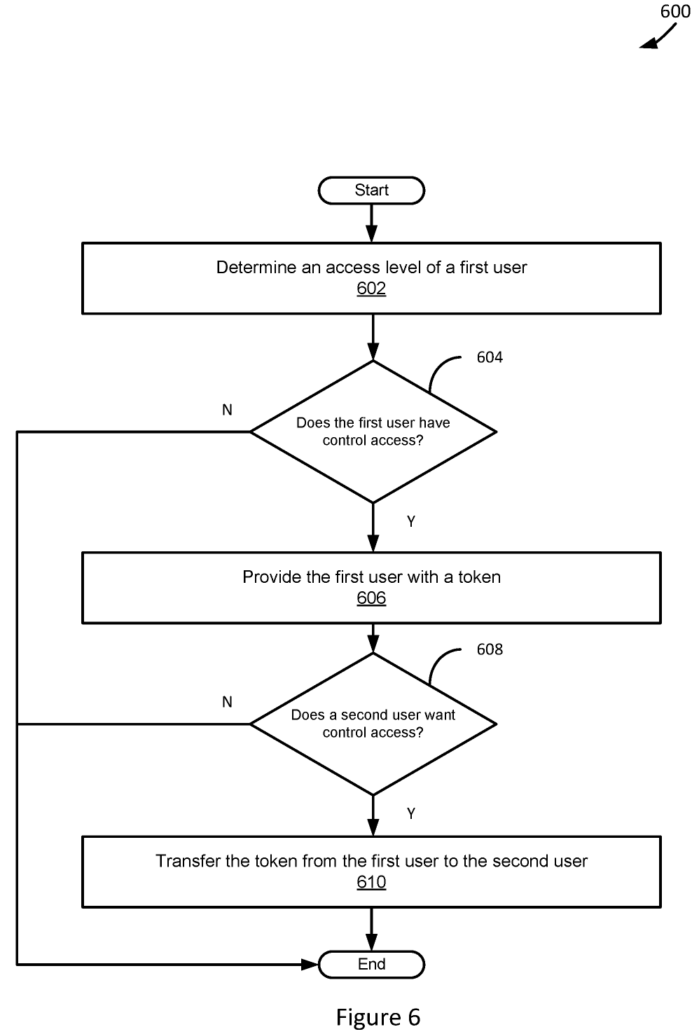

FIG. 6 depicts a flowchart 600 of an example of a method for managing access levels of users to access a single instance of an application executed remotely. The flowchart 600 begins at module 602, where an access level of a first user is determined. An applicable engine for determining access levels, such as the access management engines described in this paper, can determine an access level of a first user. Depending upon implementation-specific or other considerations, an access level of a first user can be determined at least in part using access rules.

The flowchart 600 continues to decision point 604, where it is determined if the first user has control access. An applicable engine for determining access levels, such as the access management engines described in this paper, can determine if the first user has control access. If it is determined that the user has control access then the flowchart 600 continues to module 606.

At module 606, the flowchart 600 includes providing the first user with a token. An applicable engine for managing access levels, such as the access management engine described in this paper, can provide the first user with a token. A token signifies that a user has access control to a single instance of an application executed remotely.

The flowchart 600 continues to decision point 608, where it is determined if a second user wants control access to a single instance of an application executed remotely. An applicable engine for managing access levels, such as the access management engine described in this paper, can determined if a second user wants control access to a single instance of an application executing remotely. If it is determined that the second user wants control access, then the flowchart 600 continues to module 610.

At module 610, the flowchart 600 includes transferring the token from the first user to the second user. An applicable engine for managing access levels, such as the access management engine described in this paper, can transfer the token from the first user to the second user.

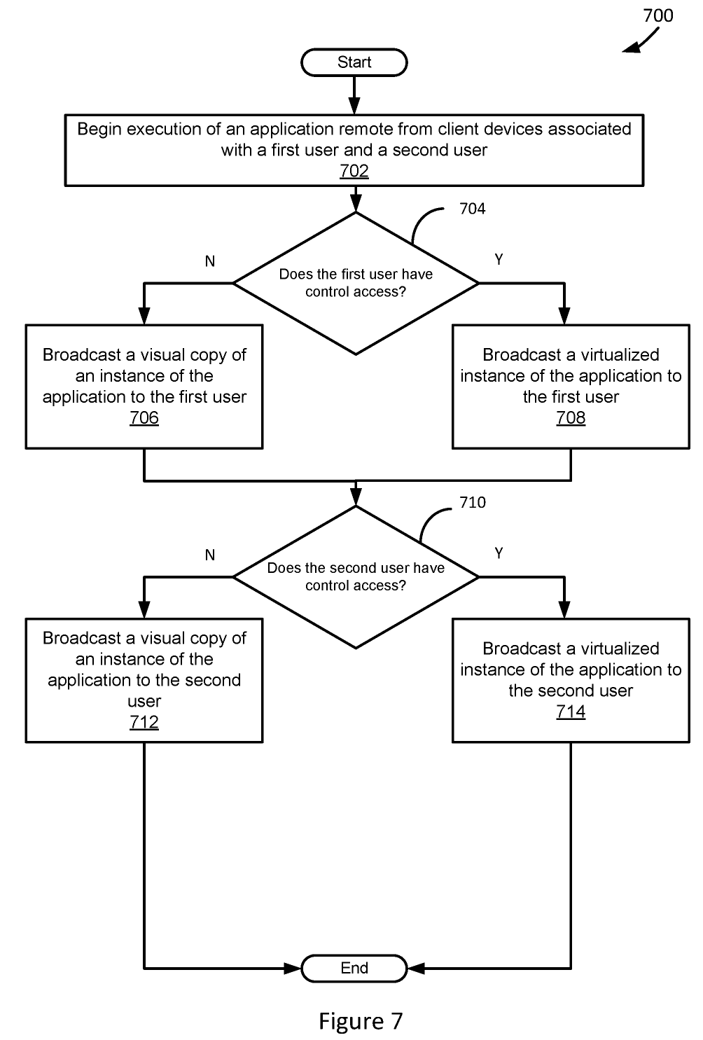

FIG. 7 depicts a flowchart 700 of an example of a method for providing access to a single instance of a remotely executed application according to access levels. The flowchart 700 begins at module 702, where an application is executed remote from a first client device associated with a first user and a second client device associated with a second user. An applicable engine for executing an application remotely from client devices, such as the seamless remote application execution engines described in this paper, can begin execution of an application remote from a first client device and a second client device. Depending upon implementation-specific or other considerations, either or both the first client device and the second client device do not have to have access to the application at the beginning of execution at module 702. For example, execution of an application can begin and a client device can subsequently connect later during a session to gain simultaneous shared access for a user.

The flowchart 700 continues to decision point 704 where it is determined whether the first user has control access to a single instance of the application. An applicable engine for determining access levels, such as access management engines described in this paper, can determine whether the first user has control access to a single instance of the application. Depending upon implementation-specific or other considerations, whether the first user has control access can be determined based on whether the first user has a token.

If it is determined at decision point 704 that the first user has passive access instead of control access, then the flowchart 700 continues to module 706. At module 706, a visual copy of an instance of the application is broadcast to the first user. An applicable system for managing access to an instance of an application, such as the remote application broadcast engines described in this paper, can broadcast a visual copy of an instance of the application to the first user. Depending upon implementation-specific or other considerations a visual copy of an instance of the application can be broadcast to the first user through a web based application accessed through a web browser executing on a client device associated with the first user. Further depending upon implementation-specific or other considerations, a visual copy of an instance of the application can be broadcast to the first user through a native application executing on a client device associated with the first user.

If it is determined at decision point 704 that the first user has control access, then the flowchart 700 continues to module 708. At module 708, a virtualized instance of the application is broadcast to the first user. An applicable system for managing access to an instance of an application, such as the remote application broadcast engines described in this paper, can broadcast a virtualized instance of the application to the first user. Depending upon implementation-specific or other considerations a virtualized instance of the application can be broadcast to the first user through a web based application accessed through a web browser executing on a client device associated with the first user. Further depending upon implementation-specific or other considerations, a virtualized instance of the application can be broadcast to the first user through a native application executing on a client device associated with the first user.

After either module 706 or module 708, the flowchart continues to decision point 710. At decision point 710, it is determined whether the second user has control access to a single instance of the application. An applicable engine for determining access levels, such as access management engines described in this paper, can determine whether the second user has control access to a single instance of the application. Depending upon implementation-specific or other considerations, whether the second user has control access can be determined based on whether the second user has a token.

If it is determined at decision point 710 that the second user has passive access instead of control access, then the flowchart 700 continues to module 712. At module 712, a visual copy of an instance of the application is broadcast to the second user. An applicable system for managing access to an instance of an application, such as the remote application broadcast engines described in this paper, can broadcast a visual copy of an instance of the application to the second user. Depending upon implementation-specific or other considerations a visual copy of an instance of the application can be broadcast to the second user through a web based application accessed through a web browser executing on a client device associated with the second user. Further depending upon implementation-specific or other considerations, a visual copy of an instance of the application can be broadcast to the second user through a native application executing on a client device associated with the second user.

If it is determined at decision point 710 that the second user has control access, then the flowchart 700 continues to module 714. At module 714, a virtualized instance of the application is broadcast to the second user. An applicable system for managing access to an instance of an application, such as the remote application broadcast engines described in this paper, can broadcast a virtualized instance of the application to the second user. Depending upon implementation-specific or other considerations a virtualized instance of the application can be broadcast to the second user through a web based application accessed through a web browser executing on a client device associated with the second user. Further depending upon implementation-specific or other considerations, a virtualized instance of the application can be broadcast to the second user through a native application executing on a client device associated with the second user.

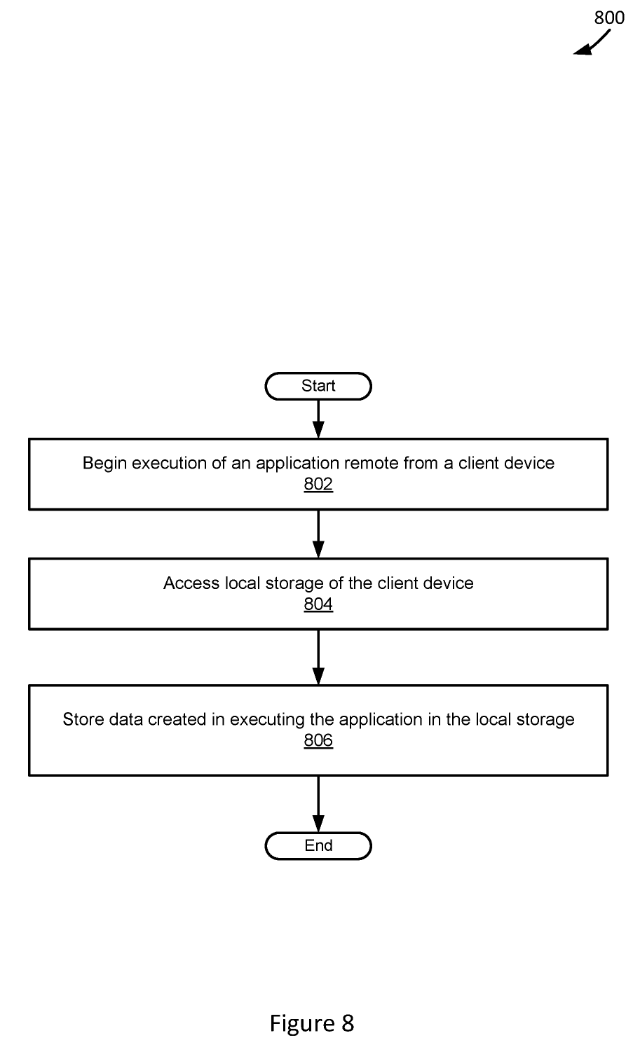

FIG. 8 depicts a flowchart 800 of an example of a method for transferring data associated with an application executed remotely from a client device to a local storage of the client device. The flowchart 800 begins at module 802, where an application is executed remote from a client device. An applicable engine for executing an application remotely from client devices, such as the seamless remote application execution engines described in this paper, can begin execution of an application remote a client device.

The flowchart 800 continues to module 804, where local storage of the client device is accessed. An applicable engine for accessing local storage of a client device, such as the data transfer engines described in this paper, can access local storage of the client device. Depending upon implementation-specific or other considerations, local storage of the client device can be accessed using a virtualized file system of the client device. Further depending upon implementation-specific or other considerations, local storage of the client device can be accessed through an application executing at the client device.

The flowchart 800 continues to module 806, where data associated with execution of the application remote from the client device is transferred to the local storage of the client device. An applicable engine for transferring data to local storage, such as the data transfer engines described in this paper, can transfer data associated with executing the application to the local storage of the client device. Data associated with execution of the application remote from the client device and transferred to the local storage of the client device can include data created in executing the application. For example, if the application is a word processing program, data associated with execution of the application remote from the client device can include a generated document.

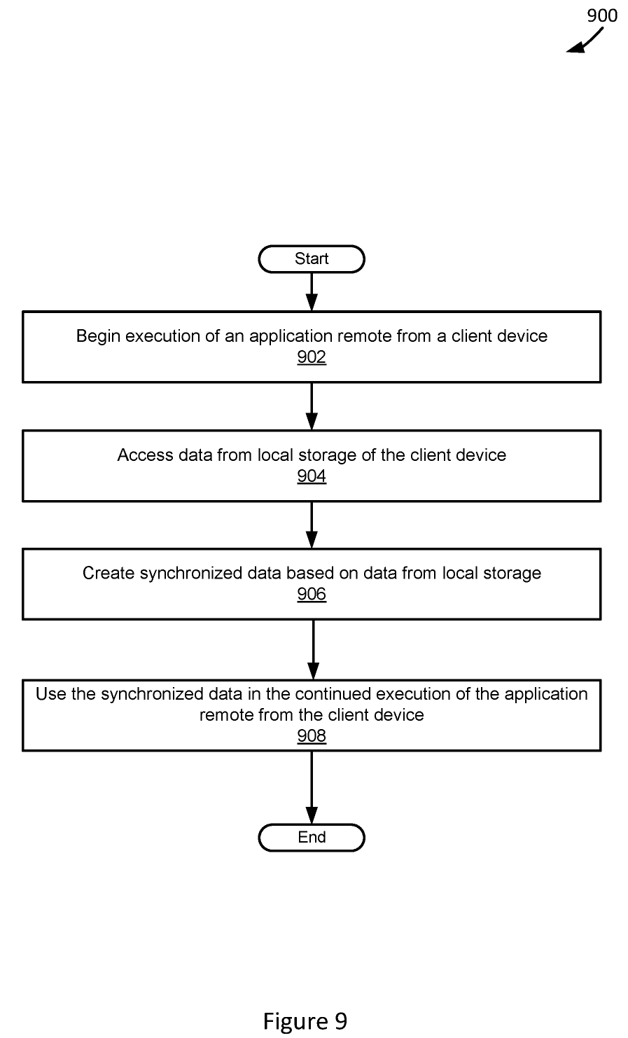

FIG. 9 depicts a flowchart 900 of an example of a method for using data in a local storage of a client device in the execution of an application remote from the client device. The flowchart 900 beings at module 902, where an application is executed remote from a client device. An applicable engine for executing an application remotely from client devices, such as the seamless remote application execution engines described in this paper, can begin execution of an application remote a client device.

The flowchart 900 continues to module 904, where data from local storage of the client device is accessed. Data from local storage can be access by an applicable engine for accessing locally stored data, such as the local data retrieval engines described in this paper. Depending upon implementation-specific or other considerations, local storage of the client device can be accessed using a virtualized file system of the client device. Further depending upon implementation-specific or other considerations, local storage of the client device can be accessed through an application executing at the client device.

The flowchart 900 continues to module 906, where synchronized data is created based on the data from the local storage. An applicable engine for creating synchronized data, such as the local data retrieval engines described in this paper, can create synchronized data based on the data from the local storage. Synchronized data can include a mirror image of the data in the local storage.

The flowchart 900 continues to module 908, where the synchronized data is used in the continued execution of the application remote from the client device. An applicable engine for executing an application remote from the client device, such as the seamless remote application engines described in this paper, can continue executing the application remote from the client device using the synchronized data.

These and other examples provided in this paper are intended to illustrate but not necessarily to limit the described implementation. As used herein, the term “implementation” means an implementation that serves to illustrate by way of example but not limitation. The techniques described in the preceding text and figures can be mixed and matched as circumstances demand to produce alternative implementations.

We claim:

1. A method comprising:
beginning execution of an application remotely from a first client device associated with a first user and a second client device associated with a second user;
determining a first access level of the first user and a second access level of the second user;
providing shared simultaneous access to a single instance of the application to the first user based on the first access level and to the second user based on the second access level;
receiving input based on interactions of at least one of the first user and the second user with a virtualized instance of the application;
continuing execution of the application remotely from the first client device and the second client device based on the input.

2. The method of claim 1, wherein the first access level and the second access level are a same access level.

3. The method of claim 1, wherein the first access level is control access, the providing the shared simultaneous access to the single instance of the application further comprising broadcasting the virtualized instance of the application to the first user.

4. The method of claim 1, wherein the second access level is passive access, the providing shared simultaneous access to the single instance of the application further comprising broadcasting a visual copy of the single instance of the application to the second user.

5. The method of claim 1, wherein the first access level is control access, the method further comprising providing a token to the first user, the token signifying that the first user has control access.

6. The method of claim 1, wherein the first access level is control access and the second access level is passive access, the method further comprising:
providing a token to the first user, the token signifying the control access;
determining that the second user wants the control access;
transferring the token to the second user.

7. The method of claim 1, further comprising:
establishing a communication channel between the first user and the second user;
transmitting data through the communication channel between the first user and the second user for providing collaboration in the shared simultaneous access to the single instance of the application.

8. The method of claim 1, further comprising:
accessing local storage of either or both the first client device and the second client device;
storing data created in executing the application remotely from the first client device and the second client device in the local storage.

9. The method of claim 8, wherein the local storage is accessed using a virtualized file system of either or both the first client device and the second client device.

10. The method of claim 1, further comprising:
accessing data stored in local storage of either or both the first client device and the second client device;
creating synchronized data based on the data stored in the local storage;
using the synchronized data in the continued execution of the application remotely from the first client device and the second client device.

11. The method of claim 10, wherein the local storage is a clipboard.

12. A system comprising:
a seamless remote application execution engine configured to begin execution of an application remotely from a first client device associated with a first user and a second client device associated with a second user;
an access management engine configured to determine a first access level of the first user and a second access level of the second user;
a remote application broadcast engine configured to provide shared simultaneous access to a single instance of the application to the first user based on the first access level and to the second user based on the second access level;
the seamless remote application execution engine further configured to:
receive input based on interactions of at least one of the first user and the second user with a virtualized instance of the application;
continue execution of the application remotely from the first client device and the second client device based on the input.

13. The system of claim 12, wherein the first access level and the second access level are a same access level.

14. The system of claim 12, wherein the first access level is control access, the remote application broadcast engine further configured to broadcast the virtualized instance of the application to the first user.

15. The system of claim 12, wherein the second access level is passive access, the remote application broadcast engine further configured to broadcast a visual copy of the single instance of the application to the second user.

16. The system of claim 12, wherein the first access level is control access, the access management engine further configured to provide a token to the first user, the token signifying that the first user has control access.

17. The system of claim 12, wherein the first access level is control access and the second access level is passive access, the access management engine further configured to:
provide a token to the first user, the token signifying the control access;
determine that the second user wants the control access;
transfer the token to the second user.

18. The system of claim 12, further comprising remote connection management engine configured to:
establish a communication channel between the first user and the second user;
transmit data through the communication channel between the first user and the second user for providing collaboration in the shared simultaneous access to the single instance of the application.

19. The system of claim 12, further comprising a data transfer engine configured to:
access local storage of either or both the first client device and the second client device;
store data created in executing the application remotely from the first client device and the second client device in the local storage.

20. The system of claim 19, further comprising:
a file system spoofer configured to create a virtualized file system of either or both the first client device and the second client device;
the data transfer engine further configured to access the local storage using the virtualized file system of either or both the first client device and the second client device.

21. The system of claim 12, further comprising:
a seamless remote application execution engine configured to:
access data stored in local storage of either or both the first client device and the second client device;
create synchronized data based on the data stored in the local storage;
the seamless remote application execution engine configured to use the synchronized data in the continued execution of the application remotely from the first client device and the second client device.

22. The system of claim 21, wherein the local storage is a clipboard.

23. A system comprising:
means for beginning execution of an application remotely from a first client device associated with a first user and a second client device associated with a second user;
means for determining a first access level of the first user and a second access level of the second user;
means for providing shared simultaneous access to a single instance of the application to the first user based on the first access level and to the second user based on the second access level;
means for receiving input based on interactions of at least one of the first user and the second user with a virtualized instance of the application;
means for continuing execution of the application remotely from the first client device and the second client device based on the input.
